(19) United States
(12) Patent Application Publication
(10) Pub. No.: US 2009/0210291 A1
(43) Pub. Date: Aug. 20, 2009

(54) MONTETIZING SOCIAL WEBSITE SYSTEM AND METHOD

(76) Inventor: Samir H. Safar, San Diego, CA (US)

Correspondence Address: Samir H. Safar, 13790 Rosecroft Way, San Diego, CA, 92130, US

(21) Appl. No.: 12/362,468

(22) Filed: Jan. 29, 2009

Related U.S. Application Data
(60) Provisional application No. 61/062,938, filed on Jan. 30, 2008.

(51) Int. Cl. G06Q 30/00; G06Q 99/00

(52) U.S. Cl. 705/10; 705/1; 705/14

(57) ABSTRACT

A system and method for monetizing social websites is described. As an example, a Monetizing Social Website System and Methods comprises the website address “ibidonyou.com.” Ibidonyou.com represents the next generation in monetizing social websites. It necessitates multiple advertisements per member page, as well as multiple ad clicks per individual member by virtue of its networking model, where members ‘bid’ on connections with credits earned from ad placements and clicks on ads. It also offers an incentive to use the credits at advertisers' online stores, furthering ibidonyou.com income from ad placement. More particularly, ibidonyou.com is a social network site where an “Agent” gains friends by bidding on them while further providing the ability to earn credits which have cash value.

### TECHNICAL FIELD OF THE INVENTION

The present invention in general relates to a system and a method for advertising and deriving economic value from websites on the World Wide Web. More specifically, the present invention relates to e-commerce and increasing traffic on “clicks to retail sites.” The invention is particularly, but not exclusively, useful as a system and method for monetizing social websites to fortify networking, and further deriving and sharing of advertisement revenue.

### BACKGROUND OF THE INVENTION

Heretofore, social networking websites have become increasing popular with the rapid emergence and growth of websites such as “Myspace.com,” “Facebook.com,” “Secondlife.com,” and “Friendster.com.” Furthermore, there is a scarce amount of available systems and methods that optimize e-commerce strategies that are needed in light of the almost staggering popularity of some social networking sites. One published patent application details a need in the art, by Graham, United States Patent Application Publication Number 2007/0150537, entitled “Social Network Advertisement System and Method.”

As told by Graham, in recent years, Social Networking Systems have gained immense popularity and attracted millions of individual users. Many Social Network Systems allow individuals to use and participate in such Social Networking Systems at little or no cost. In order to generate revenue to support the operation of such on-line activity, a number of Social Networking Systems publish banner advertisements within portions of the user interface (that is, the owners of Social Networking Systems often sell advertising space within portions of the user interface). Although banner advertisements have provided owners and operators of Social Networking Systems with a minimum level of advertising revenue, improved methods and advertising products are needed to enable such owners and operators to generate additional advertising revenue.

Further, in order to forecast the model of the next generation of popular websites, it appears that some of the most popular websites involve not only connecting people, but also the excitement of gambling. For example, eBay.com.com involves the thrill of gambling in which people bid on products and hope that they end up with the winning bid on whatever trinket or treasure they desire. Websites like YouTube.com, MySpace.com, and Facebook.com grew in popularity at an unforeseen exponential rate, gaining hundreds of thousands if not millions of users in a given day or week. The human need for connectivity and community, as well as self expression found their realization on a truly global scale in these networking websites. People can sign on and find out how many people viewed their sites, receive friend requests as well as reconnect with long lost friends or strengthen current relationships. These networking sites have attracted public figures from entertainers, to news anchors, to politicians, and all those who use the websites to get their messages and projects to a greater number of people, allowing regular fans and citizens a direct access to these people that they would never have had in today's society.

As per the survey done by industry experts regarding the future of social networking sites, some of the experts believe that the United States social network ad spend is estimated to reach $2 billion by 2010. According to Hitwise, a company providing search intelligence for online advertising and search marketing, “My Space's growth rate was gradual, but it enjoyed a 4,300 percent increase over a two year period. This site has increased more than we've seen in my memory of any of the sites we track.”

According to Hitwise, the social networking sites such as Facebook, Myspace, and Bebo have received more Internet traffic than the email websites such as Gmail, Yahoo, and Hotmail across the world in recent times. The growth rate has been significant in recent times, as just a year ago the email sites had double the traffic of social network sites. The statistics shows that the communication between friends using social network is starting to eat into web based email traffic. Perhaps more importantly, the statistics show that clicks to retail sites from social networking sites are now equivalent to the traffic generated from the web-based email sites. In other words, while many businesses view social networks as entertaining distractions, referrals via social networks are generating e-Commerce activity.

Therefore it becomes apparent from the above discussion that there is a need for a system and a method to provide advertising and further deriving economic value from websites on the World Wide Web.

### SUMMARY OF THE INVENTION

The present invention described herein relates to a system and a method for monetizing social websites that satisfies the need. The object of the present invention to provide a Monetizing Social Website System and Method that combines the excitement of gambling and cash credit procurement with connectivity and expression in social website models.

Another object of the present invention is to provide a model for a social website that gives the members of the social website an opportunity to customize their own profiles with advertisements of their choice.

Yet another object of the present invention is to allow the members of the social website to earn credits having cash value based on profile visitors clicking on ad placements.

Yet another object of the present invention is to provide protection from abuse of a system that rewards members for “clicks to retail.”

Yet another object of the present invention is to provide a social website that allows its members to bid on the friendships with other members of the social website.

Yet another object of the present invention is to provide a referral system for credits for ad clicks in the event a visitor starts at an original profile and then clicks to a member friend of the original profile with subsequent ad placement click.

Yet another object of the present invention is to provide a social website member with a social profile interlink wherein members can import their existing profiles from another website to the website of the present invention.

Yet another object of the present invention is to provide a social website that allows for a friend hierarchy for placing friends on particular levels associated with availability to particular profile pages inter-linking to other friends.

Yet another object of the present invention to provide a social website that provides a “Treasure Chest” feature wherein advertisers and website providers offer prizes to users for promotional purposes.

Yet another object of the present invention is to provide a “Look-Alike” feature, wherein users can search and bid on friends based on particular physical features.

Yet another object of the present invention is to provide a feature that identifies and assigns status to an agent based on an agent wealth and the agent particular success in accumulating credits. These and other features, aspects, and advantages of the present invention will become better understood with reference to the following description. This summary is provided to produce a selection of concepts in a simplified form. This summary is not intended to identify key features or claimed features of the present invention, nor is it intended to be used to limit the scope of the claimed invention.

### BRIEF DESCRIPTION OF THE DRAWINGS

The novel features of the present invention, as well as the invention itself, both as to its structure and its operation, will be best understood from the accompanying drawings, taken in conjunction with the accompanying description, in which similar reference characters refer to similar parts, and in which:

FIG. 1 illustrates a flowchart model showing the steps that are carried out by an agent to purchase credit with respect to one embodiment of the present invention.

FIG. 2 illustrates a flowchart model showing the steps that are carried out by the agent to post auctions with respect to one embodiment of the present invention.

FIG. 3 illustrates a flowchart model showing the steps that are carried out by the agent for bidding in an auction with respect to one embodiment of the present invention.

FIG. 4 illustrates a flowchart model showing the steps that are carried out by the agent to purchase credit with respect to one embodiment of the present invention.

FIG. 5 illustrates a flowchart model showing the steps that are carried out by the agent to become a lending agent with respect to one embodiment of the present invention.

FIG. 6 illustrates a flowchart model showing the steps that are carried out by an agent for a loan request to a lending agent with respect to one embodiment of the present invention.

FIG. 7a, 7b, 7c, and 7d illustrate a flowchart model for exemplary webpage's with respect to one embodiment of the present invention.

FIGS. 8a and 8b further illustrate a flow chart for exemplary webpage's with respect to one embodiment of the present invention.

FIG. 9 is a schematic illustration of a scrolling display of prize winners with respect to one embodiment to the present invention.

Reference will now be made in detail to the present preferred embodiments of the invention, examples of which are illustrated in the accompanying drawings. Wherever possible, the same reference numbers are used in the drawings and the description to refer to the same or the like parts.

### DETAILED DESCRIPTION OF THE DRAWINGS

A system and method for monetizing social websites is described. As an example, a Monetizing Social Website System and Methods comprises the website address “ibidonyou.com.” Ibidonyou.com represents the next generation in monetizing social websites. It necessitates multiple advertisements per member page, as well as multiple ad clicks per individual member by virtue of its networking model, where members ‘bid’ on connections with credits earned from advertisements (ad) placements and clicks on ads. It also offers an incentive to use the credits at advertisers' online stores, furthering ibidonyou.com income from ad placement. More particularly, ibidonyou.com is a social network site where an “Agent” gains friends by bidding on them while further providing the ability to earn credits which have cash value.

In the present invention, Agents refer to individuals that are officially logged onto the website ibidonyou.com. These are the people who have signed up for pages.

In the present invention, Advertiser is referred to a Company or an individual enrolled in the ad bank. These parties are charged by ibidonyou.com for their current and subsequent ad placement and ad click.

In the present invention, Ads Bank is referred to a database where all active ads for placement on Agent's Profiles are located. There will be two ad banks; one for general advertisements and one for adult-only content advertisements.

In the present invention, Credit is referred to the value of advertisers' clicks assigned and given to Agents only by ibidonyou.com. Each credit has a cash value that will be assigned by ibidonyou.com.

In the present invention, Credit Account is similar to a bank account. The credit account will show how many credits an Agent has procured, how much cash value these credits have, and a transaction history. Each Agent is eligible for whole or partial credits according to ibidonyou.com terms and conditions.

In the present invention, Friendship is a link established between Agents once one Agent has won a bid posted by another Agent.

In the present invention, Non-Agent is the Visitor to the site that does not have an official log in or site page.

In the present invention, Private Agent is referred to the Agent who has paid for the privilege of a profile that is not viewable by anyone other than Agents with whom the Private Agent has secured friendship.

In the present invention, Public Agent is referred to an Agent who has not paid through credits for the privilege of hiding their profile synopsis. These Agents are not allowed to use their credits for anything other than bidding on other Agents' friendships.

In the present invention, Referral Agent is referred to an Agent entitled to a partial ad click credit on a linked agent's site.

Ibidonyou.com, as an exemplary embodiment of the present invention, is a social networking website where Agents can create unique multi page profiles. Agents can load pictures and videos, link with other Agents according to the model ibidonyou.com intends to employ, and eventually open a limited e-commerce page. Links between agents are established by winning “bids” on friendships using credits gained through ad placement on their profiles as well as clicking on other Agents' placed ads.

The model of ibidonyou.com provides the excitement of gambling and winning like eBay.com, as well as the connectivity and expression available in a model like MySpace.com. Through a unique credit-per-click model, the Agents place advertisements on their profiles to get credits to bid for friends and as well as be bid on as a friend by other Agents.

The very mechanism that will fund ibidonyou.com will make each friendship more attractive. As with any social networking site, there will be friends who will join in groups. While the initial visitors will join after viewing an advertisement, many people will subsequently join by virtue of word-of-mouth from a friend who already is active on such a site. But still further there will be people who join out of sheer curiosity or, once ibidonyou.com takes off, who will join to be part of the latest trend. While the friends who join in groups will likely accept very low bids for friendships, expansion beyond a current circle of friends will require a greater number of credits. In order to earn credits more quickly it will be advantageous to add as many advertisements to each profile as possible. By extension, it will pay to be connected to people with more friends and connected to people with more ads as referral credits can be earned through visitors that start at your site and end at a friend's while clicking on an advertisement.

Advertisers are solicited for a link or multiple links available to ibidonyou.com members known as agents. Those companies who do want to advertise through ibidonyou.com profiles provide ads (simple links, pictures, videos, etc.) to be placed in an ad bank. This Ad Bank will be accessible to Agents for customized advertising on their profiles. The advertisers will be solicited through online solicitation strategies, and as well as direct mailing strategies. The online solicitation strategies utilize targeted advertising, where ads are placed on sites visited by advertisers that are more likely to be interested in advertising on ibidonyou.com. Once the advertisers have registered for an advertisers account on ibidonyou.com, they will have a secure access portal where they will be able to upload ads of their choice and manage files already added.

Initially, the Agents register for a free profile on the site ibidonyou.com of the present invention and receive fifty (50) credits to start their account. As part of the profile building process, the new Agent will be prompted to choose which ads to place on his or her profile and where they would like the ads to appear.

Further to one embodiment of the present invention, the agents and the Non-Agents may browse public sections of the profiles. The public sections of each profile include a main picture, a 200 character maximum synopsis provided by the Agent and the advertisements each Agent chooses for his or her unique profile. Agents have the option to spend the fifty (50) credits on privatization of their profile, or hiding additional content other than their picture and advertisements and thus will gain Private Agent status. Private Agents are the only members that have the ability to use their credits towards merchandise. All merchandise available on ibidonyou.com will have a value of at least fifty (50) credits. By only allowing those who used their initial credits to privatize their accounts and setting the number of credits for merchandise at fifty (50) credits, there is a safeguard against someone joining, buying one thing with their initial credits and then never returning to ibidonyou.com.

Further, Agents earn credits with actual cash value based on the number of clicks the advertisements placed on their pages receive; and also when credits are earned, they enjoy Referral Agent status. Referral Agent status occurs when a visitor starts at said Agent's profile, continues to one of their friends' sites, and click on ad(s) at the friend's site. These credits are deposited into their ibidonyou.com credit account. The Agent can use these credits for several different purposes; most significantly credits are used for the purpose of obtaining friends that are fellow Agents. Each Agent can set his or her own value of friendship, or the number of credits another Agent needs to bid on a link to said Agent. The Agent can also use his or her amassed credits towards purchasing Private Agent Status after joining or to use as cash value at advertisers' online stores enrolled with ibidonyou.com.

This ability to use credits as cash at retail websites is an unique feature, currently not available on any existing social website and thus serves as a draw for internet users to join our particular networking site; however, Agents are encouraged to spend their credits on bidding on friendships with other users to expose their own profile to more visitors and thus more clicks. Once an Agent secures a friendship with another Agent by winning a bid on friendship the possibility of Referral Agent status is realized for either Agent.

A particular invention embodiment provides safeguards to prevent “cheating” in regards to the number of clicks allowed by any individual on each agent's ads. By utilizing a click-counting mechanism ibidonyou.com will not allow for more than five (5) clicks to be credited without purchase from the advertiser (See “Click Count Mechanism” herein). Also, ibidonyou.com will conduct random regular audits to ensure that any credits gained through cheating will be removed from the offending Agent's credit bank.

### EXAMPLES

As an example of building social website monetization according to the present invention, first, the advertisers are solicited through online advertising strategies that place ads on multiple sites that are likely to attract the sort of customer that would be interested in a site like this as well as a traditional direct mailing campaign.

Second, interested advertisers will contact ibidonyou.com to provide ads that Agents can place on their profiles. These advertisements will be placed in an Ads Bank able to be perused by Agents.
Third, Agents are found through the same online advertising strategies as outlined for advertisers.
Fourth, Agent A creates his/her own page on ibidonyou.com and receives 50 “New Agent” credits to start bidding on friends immediately or to secure Private Agent Status to use future credits as cash at advertisers' sites.
Fifth, Agent A places ads of their choice on their page(s) from the advertisers' bank of ads.
Sixth, Agent A places his/her bid ad on the bid feature for other Agents to bid on a friendship with Agent A.
Seventh, Agent A places a bid value for other Agents to be his/her friend.
Eighth, Agent B has also created a page and placed ads on his or her profile.
Ninth, through clicks on ads on Agent B's profile, Agent B has amassed a quantity of credits and thus goes to the bid feature to bid on links to other Agents as friends.
Tenth, Agent B is interested in friendship with Agent A.
Eleventh, Agent B has enough credits to bid on a friendship with Agent A and thus places a bid.
Twelfth, Agent B wins the bid and he/she now has access to Agent A's site and those friends of Agent A and vice versa.
Thirteenth, Agent B can only view the public areas of Agent A's friends and vice versa.
Fourteenth, Agent B views a profile of one of Agent A's friends whom we will refer to as Agent C. Agent B clicks on one of Agent C's advertisements.
Fifteenth, Agent C earns the credit for his or her advertiser receiving a click. Since Agent B linked to Agent C via Agent A's profile, Agent A becomes a Referral Agent and receives a one-fifth click credit as a result.
Sixteenth, in addition to using credits to bid on friendships, Agents may utilize their credits to purchase products through advertisers featured on ibidonyou.com OR to privatize their entire site with the exception of their photograph and user name. Agents must use fifty (50) credits to privatize their profiles.
Lastly, Agent A privatizes his/her profile and can now use his/her amassed credits as cash value at advertisers' sites in addition to bidding on friendships with other Agents.

The following is a list of exemplary internal features according to a preferred embodiment of the present invention.

One, advertisers place their ads or other media into the advertisers' Ads Bank on ibidonyou.com. Each advertiser has their own unique portal to access links for uploading their ads, video clips, or other media.

Two, ibidonyou.com calculates each advertiser's clicks internally per Agent's site.
Three, these clicks are validated and credited according to the rules of clicks earned.
Four, ibidonyou.com gives credit or cash value to the Agents' credit account that is associated with each click per ibidonyou.com rules.
Five, Agents have access to a bidding portal where they can put their friendship up for bidding as well as bid on other Agents they want to befriend.
Six, a click-counter mechanism will be in place to ensure that this site is not abused as a pay-per-click type system as further detailed herein.
Still further, internal features include the eventual capability for each agent to open a very limited e-commerce page. It will be a very simple web store with strict rules. Agents will NOT be allowed to sell advertisers' product lines or similar products. Any breach of this rule will result in immediate closure of the offending Agent's profile. Used properly, of course, this will increase the revenue stream as ibidonyou.com would have the rights to a percentage of each sale. This will also add a unique feature to a social networking site that at present is not offered.

The following are exemplary click rules mechanisms according to a preferred embodiment of the present invention.

First, there are click counters unique to each Agent's URL as well as each IP address.
Second, an Agent can click on other Agents advertisers and earn credit.
Third, Agents' credits are maintained in a credit bank.
Fourth, an Agent CANNOT earn credits by clicking on the advertisers on his or her own site.
Fifth, the only exception to this rule is if the Agent purchases items from the advertisers on their website.
Sixth, an Agent can earn a maximum of five (5) credits or clicks from the same advertiser from the same computer or IP address WITHOUT purchase.
Seventh, any subsequent clicks will not be credited until purchase.
Eighth, if a purchase is made, the count returns to zero (0) clicks and the agent can earn an additional five (5) credits.
Lastly, if for some reason an agent can circumvent the system, ibidonyou.com will conduct regular audits. If it finds an Agent that has abused the system, ibidonyou.com reserves the right to debit the offending agent's credit bank accordingly with possible closure of accounts of Agents that are repeat offenders.

In yet another preferred embodiment, a set of rules is provided in view of Adult Advertisement material. Accordingly, among the advertisers that will be invited to join ibidonyou.com advertising bank will be adult material advertisers such as gambling, alcohol and tobacco advertisers as well as those that advertise material of a sexual nature. Ibidonyou.com will honor the prevailing rules of the Agents' home states and countries regulating legal age for all classes of adult advertisements. There will, however, have to be strict guidelines in place to ensure ibidonyou.com does not allow minors to either post this material on their sites or to have access to the advertisements on adult Agent's sites.

While registering for their sites, new Agents will be required to verify that they are 18 or older. If they indicate they are 18 or older, they will be given the option to register as a “Sinful Agent” or a “Saintly Agent;” basically they will be asked whether they want to post advertisements for adult-only material or if they want to post advertisements appropriate for all ages.

Three key points will be made clear on the page where the adult Agents can choose to be Sinful or Saintly Agents. The first point is that those who register as a Sinful Agent will NOT be allowed to bid on friendships of those under 18 and that those under 18 will NOT be allowed to view ANY of the Sinful Agent's profile or bid on the Sinful Agent's friendship. Second, once the Agent chooses to be a Sinful Agent they may ONLY post adult material advertisers on their websites. Finally, a clear warning will be made that any Agent who attempts to violate these policies or is found to be a minor will have their account terminated immediately, losing all credits and cash value and will not be allowed to register for a new site. Each Sinful Agent will be required to check boxes next to all three of these policies separately to ensure that each Sinful Agent knows exactly to what they are agreeing.

Any Agent that declares that he/she is below 18 years will only have the option to have access to the general advertisement ad bank. They will also be informed that they will not be allowed access to Sinful Agents after their registration is complete to avoid anyone from being able to go back and alter their age. Once the adult Agent decides whether to be a Sinful or Saintly Agent, they will have access to either the adult-only material advertisement or the general advertisement ad bank as appropriate. This will prevent the ability for Agents to post a mix of general advertisements and adult advertisements on the same profile. Also, adult Agents will have an icon posted on their Bid Advertisement on the friendship bidding floor to indicate their status as Sinful Agent or Saintly Agent so that everyone will know their status immediately.

Ibidonyou.com incorporates features that are included on MySpace.com or Facebook.com websites, however likely in a different way. These include, but are not ultimately limited to: a fully customizable multi-user profile system—meaning that the system will have the capability to allow multiple Agents and/or Non-Agents to simultaneously view a given Agent's profile, therefore traffic volume is not limited to the number of Agent's sites but can be set to whatever volume ibidonyou.com deems necessary; fully customizable profiles—allowing the Agents to truly make their profile their own, including personalized wallpaper and the ability to add additional profile fields, as well as the ability to edit default profile fields, in addition to music add-ins applied.

Other features of this nature include: advanced publishing system—allowing an Agent to incorporate streaming video clips directly into his or her site; this option also allows for the addition of rich multimedia, including interactive graphics; an unlimited number of additional pages configured via an advanced Content Management System (CMS)—each Agent can have video pages, photo pages, etc. arranged as the Agent sees fit; an event calendar—to include features such as event categorization, tagging content with relevant pictures or videos, links to search engines and external websites, and more.

Yet still additional features of this nature include: various forum options, including bulletin boards for Agents to post comments and start a conversation as well as real-time messaging, or “instant messaging” for two Agents to have a real time private conversation or for several Agents to chat simultaneously in a chat room; a video communication utilizing web cameras and live Agent-to-Agent chat upon a dedicated server upgrade; and Search Engine Optimization (SEO)—ensuring that ibidonyou.com pages will appear at the top of searches on the top search engines such as “google.com,” “yahoo.com,” and “msn.com.” Many of the smaller search engines out there use one of these three as their base and as such targeting these large search engines covers a vast majority of the search engine traffic.

As yet another feature applicable to the present invention, a social profile interlink is provided. This particular option is not currently available on the most popular social websites, Facebook.com or MySpace.com. The social profile interlink feature will allow the Agent to import their current profiles from one of those sites directly into ibidonyou.com. All the Agent will be required to do is provide their log in information (i.e. email and password) for the appropriate site and all information will be instantly imported. This will save Agents the time and effort of building a profile from scratch. It will also allow the Agents' pages to be easily recognized by friends from those other social sites. Ibidonyou.com will also offer a bonus of twenty-five (25) credits for using this feature.

In still further another feature of the present invention, a friend hierarchy is provided. The concept is relatively simple. A built-in program is provided that allows Agents to assign their friends to different “levels” that afford them different privileges within the Agent's group of friends. The exact names of the levels are customizable by the Agent, with ibidonyou.com withholding the right to remove levels with names that are inappropriate. Moreover, an Agent is able to create up to seven (7) distinct levels, for example, and is allowed to put as many of their friends in each level as they desire. Those friends that occupy the top level of the Agent's friend hierarchy will enjoy full access to information about every friend on the Agents list. However, as a friend is placed at a lower and lower level on the hierarchy their access to information about other friends of the Agent will become more and more limited. Friends will only be able to access full information on those other friends of the Agent that occupy the same or a lower level on the friend hierarchy. Included in the information available will be exactly which friends are in which level of the hierarchy. This option will only affect the information about the other friends of the Agent that the friend can see—even those friends on the lowest level of the hierarchy will not be restricted from any part of the Agent's profile. The following is an example of the friend hierarchy of the present invention. Initially, Agent A has friends W, X, Y, and Z. Agent A has chosen to have 3 levels for his friend hierarchy and names them Gold, Silver, and Bronze levels. Agent A places friend W in the Gold level, friends X and Y in the Silver level and friend Z in the Bronze level. Friend W has full access to all the information on all the other friends. While friends X and Y can view each others' information as well as friend Z's, they CANNOT view the full profile of friend W. They also will not know who the friend is in the Gold level, only that Agent A has assigned one friend to the Gold level. Friend Z can only access his own full profile and that of Agent A but not that of any other friend in this example, as the other three all occupy higher levels in Agent A's friend hierarchy. Friend Z will also only know that there is one friend in Agent A's Gold Level and two friends in the Silver Level but not know exactly which friend is in which level.

Still another aspect of the present invention involves “Pixel-Size Driven Advertisement.” A pixel is the very smallest piece of internet web real estate. Any given web page is made up of one million pixels. While selling an individual pixel will not yield noticeable space, the most popular model sells pixels in 10×10 blocks, or 100 total pixels. How this works is that each advertisement has its area on the page. When you roll over that advertiser's area, a bar of information pops up to give you a little more information so you can decide if you want to visit that advertiser.

In internet advertisement, each website owner decides how much a pixel will cost. Currently, from the most popular sites that utilize this sort of advertisement, the asking price of each pixel is anywhere from 0.01 USD to 1.00 USD. The most successful of these models was able to sell all one million pixels at 1.00 USD for 1,000,000 USD profit. The reason that advertisers would utilize this strategy is lifetime placement: once they pay for the pixels and their ad is placed they have lifetime web exposure for a minute initial investment.

This model of Pixel-Size Driven Advertising begs for ibidonyou.com ingenuity as shown herein. First, ibidonyou.com is ultimately an infinite-page website that could easily open multiple pages for dedication to Pixel-Size Driven Advertisement as this model currently exists. When the first page fills another page can be open. It also allows for advertisers to bid on pixels. A page that is nearly full of ads can do one of two things; either it will lead visitors to scroll around and find something they like or drive them away because of the visual “busy-ness” of such pages. A page that has relatively few ads is easier on the eyes and also allows each advertisement to stand on its own merit. Therefore, those pages that are just after the full pages of pixel ads will be quite attractive to advertisers to allow them the freedom to choose their placement on the page as well as their exact size. That makes these pages more valuable and as such will allow ibidonyou.com to ask a higher rate per pixel on those pages.

In addition to the dedicated Pixel-Size Driven Advertisement pages, advertisers will have the ability to add Pixel-Size Driven Advertisements into the Ad Bank for Agents to place on their pages for credit and clicks. The following is a simple example, not allowing for variation in ad size: 1 million pixels per page at 0.50 USD (average)=500,000.00USD per page, 100 pixel blocks sold=10,000 ad spaces per page=50 USD per ad, (on average) each Agent dedicates 1% of its page to adding pixel ads=100 pixel ads per Agent page=5000.00 USD per Agent Page on Pixel ads only 1,000,000 Agents by end of first year (VERY conservative)×5000.00 USD in pixel ads=$5,000,000,000 (FIVE BILLION USD) in the first year. As you can see, this option creates quite a bit of cash quickly and easily. As this creates more ads per page on which Agents can receive credit, it would be unreasonable for an Agent to not give up 1% of their page for this.

Still further aspect of the present invention has been named the “Treasure Chest.” This feature will have the benefit of not only drawing people to join, but also it provides a chance for advertisers to find a spotlight on the initial landing page. More particularly, advertisers will have access to a so called “Treasure Chest Portal,” where they can submit promotional products or special offers to be given away to Agents at random. When submitting a product or promotion to the Treasure Chest Portal, they will also provide a link to be inserted into the prize announcement sent to the Agent. This link will allow a direct route for the winning Agent to claim their prize easily. Also, the site ibidonyou.com of the present invention, will be giving away prizes of its own, such as bonus credits, free dinners, travel tickets, and the like.

Further to the Treasure Chest feature, a randomizer program will choose one of the offers currently available in the Treasure Chest Portal and choose one of the Agents. Ibidonyou.com will have absolutely no way to control the outcome to preserve the feature's integrity. Every winner and prize will be automatically chosen by the randomizer program and only through the randomizer.

Moreover, each Agent will have a Treasure Chest icon that appears on their home page. Agents will not be able to tell if they have won until they click on the Treasure Chest icon. Also, included is a means of monitoring the number of clicks on the treasure chests for statistical study on the interest in this concept. Upon clicking on the Treasure Chest icon, the Agent will discover what product or special offer they have won that day and will be directed to a web page that will allow them to redeem their prize via the original link provided by the advertiser who submitted the product or promotion or to the redemption page on ibidonyou.com if the Agent won a prize offered directly from the website.

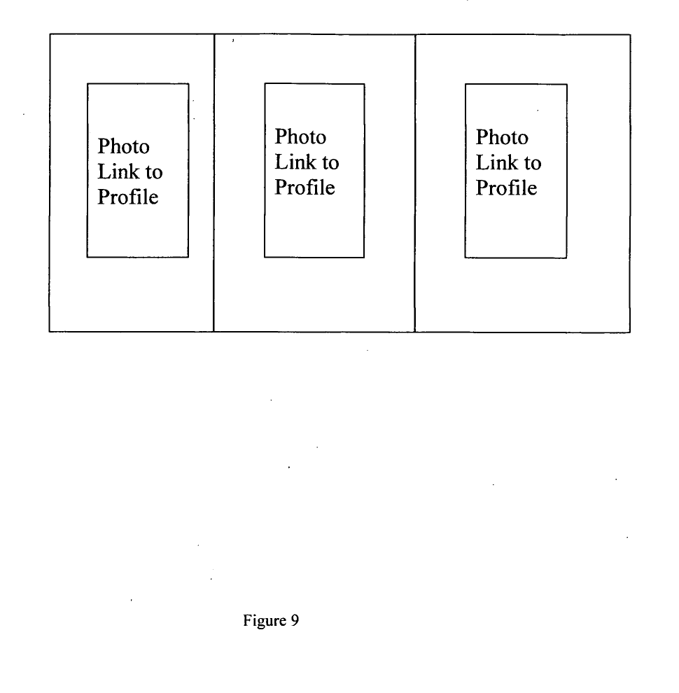

With the intention that everyone who visits an initial landing page is aware of this feature on the website, every day's winner will appear on the landing page for one week. There will be a right-to-left scrolling slide show to include the winning Agent's picture, name, and a brief description of the prize won. Each set of information, picture, name, and prize, will be approx 1″ wide by 1.5″ tall, by way of example and not by way of limitation, with a colored frame around the Agent's photo with their name across the top and two lines of text across the bottom. The first such text line will say WINNER, in all capital letters with the prize description below. Additionally, three photos across will be viewable at any given time, for a total width of 3″ for the viewable area of the slide show. FIG. 9 illustrates the winner's slideshow as described herein. This particular Treasure Chest feature has the additional benefit of displaying to every website visitor that there is a winner everyday and provides to the winning Agent site wide exposure for one week.

A still further feature to the present invention has been named the “Look Alike Feature.” This particular feature is characterized wherein Agents are able to search for friends to bid on based on matching certain facial features. Each facial feature has a menu screen where people can choose different smiles, different cheekbones, different eye colors and shapes, different noses, different chins, etc. Agents are able to choose up to 3 facial features to search at one time. Exemplary facial features could include: blue almond shaped eyes, small upturned chin and wide smile.

Also related to the Look Alike Feature, is a “Hottest Agent” contest of the present invention. Accordingly, Agents can opt into consideration for the weekly title. All Agents will be able to vote with a winner declared each week. The winning Agent would receive 50 credits as a prize. By rule, there will be no limit to the number of votes an Agent has in a given week's contest. However, each Agent is limited to three total entries in the contest over the lifetime of their account.

In still further an addition novel feature to the present invention, any particular Agent's wealth is displayed as follows. The number of credits, as well as the number of friends that an Agent has at any particular moment, are displayed in the Agent search feature, while searching for friends to bid on. Tied into the display of the number of credits the Agent currently has, classes will also be established based on the number of credits an Agent maintains in his account. Just like in real life, if their credit balance dips below the threshold they will be demoted in class. The structure is as follows:

| Credits in Account | Class Name |
|---|---|
| 0-500 | High School Student |
| 501-1000 | College Student |
| 1000-1500 | Elementary School Teacher |
| 1501-2500 | Cubicle Rat |
| 2501-4000 | Manager |
| 4001-6000 | Mogul |
| 6001-8500 | Jet-Setter |
| 8501+ | Celebrity |

Certain information is provided when searches are performed according to the present invention. Specific searches as discussed herein are the user search, bid on user search and Look Alike search. Information provided is as follows:
a. Photo
b. User Name
c. Location
d. Most Recently Graduated Educational Institution and Graduation Year
e. Wealth
f. Class
g. Number of Friends
h. Company where Currently Employed if provided

While the particular Monetizing Social Website System and Method as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

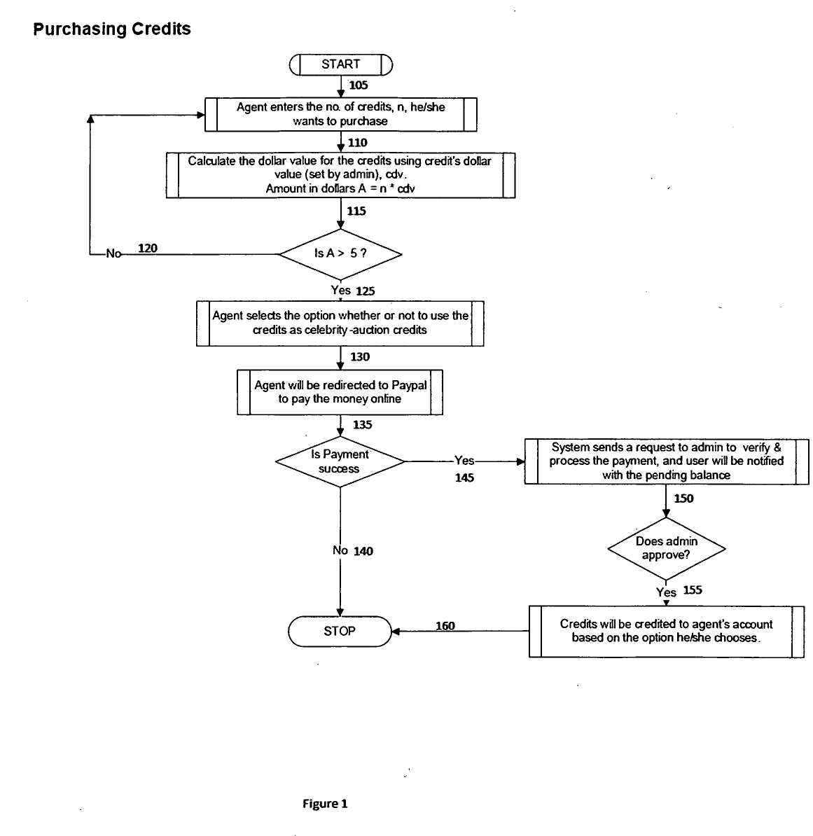

FIG. 1 illustrates a flowchart model showing the steps that are carried out by an agent to purchase credit with respect to one embodiment of the present invention.

In step 105, the agent will start the application and enter the number of credits (n) that he/she wants to purchase. In step 110, the dollar value for the credits is calculated using the credit's dollar value set by the administrator, and is called cdv. Thus, the amount in dollar value (A) is calculated as n* cdv. In step 115, amount in dollar value (A) is calculated as n* cdv is checked if it is greater than 5. In step 120, if the amount in dollar value (A) is less than 5, then the agent reenters the credits (n) he/she wants to purchase. Whereas in step 125, if the amount in dollar value (A) is greater than 5, then the agent selects the option of whether or not to use the credits as celebrity auction credits. In step 130, the agent is redirected to Paypal in order to pay the money online. In step 135, the system checks if the payment is successful. In step 140, if the payment done by the agent is not successful, the application in the system will stop and end. Whereas if the payment is successful in step 130, in step 145 the system will send a request to administrator to verify and process the payment, and the agent will be notified with the pending balance. In step 150, the approval from the administrator is checked. Further in step 155 if the administrator approves the request of agent, credits will be credited to agent's account based on the option he/she chooses and thus the application stops in step 160.

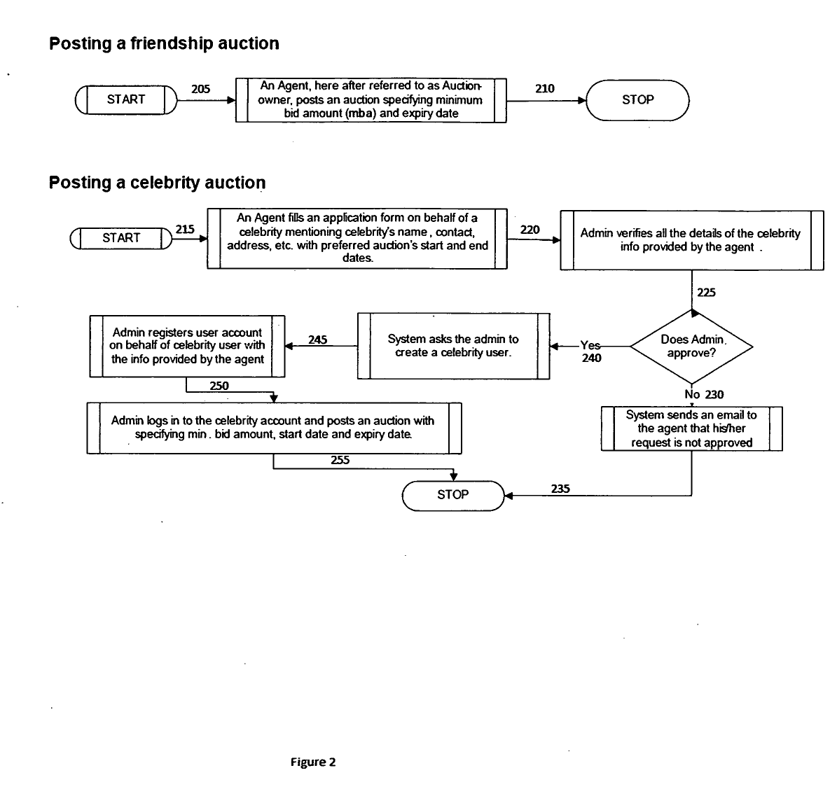

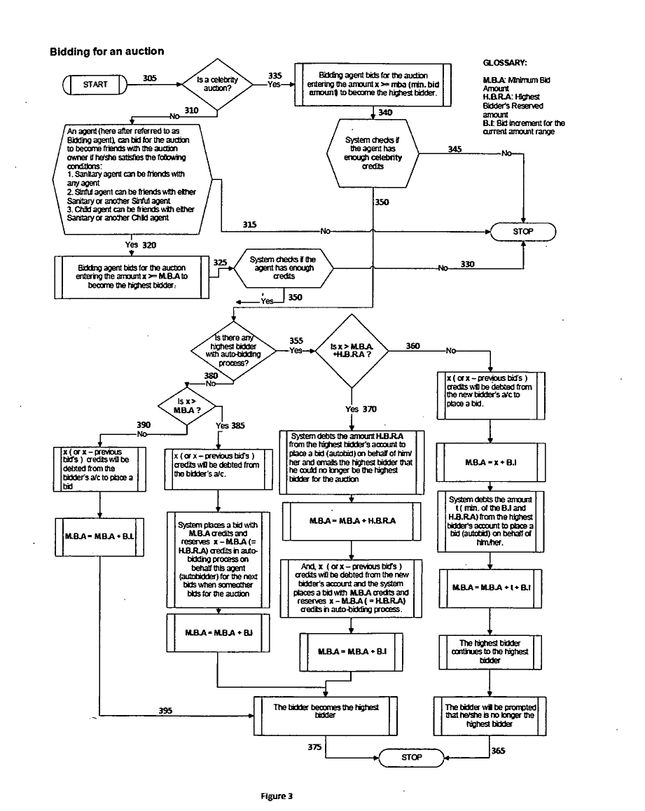

FIG. 2 illustrates a flowchart model showing the steps that are carried out by the agent to post auctions with respect to one embodiment of the present invention.

In step 205, the agent hereinafter referred to as auction-owner starts the application for posting a friendship auction and posts an auction specifying minimum bid amount (mba), and the expiry date. In step 210, the application is stopped.

In step 215, the agent starts the application for posting a celebrity auction and fills an application form on behalf of a celebrity mentioning celebrity's name, contact, address, etc with preferred auction's start and end dates. In step 220, the administrator verifies all the details of the celebrity info provided by the agent. In step 225, the administrator approval is checked. In step 230, if the administrator does not approve the request of the agent, the system sends an electronic mail to the agent stating that his/her request is not approved and the application is stopped in step 235. In step 240, if the administrator approves the request of the agent, the system asks the administrator to create a celebrity user. Further in step 245, the administrator registers user account on behalf of the celebrity user with the information provided by the agent. And finally in step 245, the administrator logs into the celebrity account and post an auction with specifying minimum bid amount, start date and the expiry date. In step 255, the application is stopped.

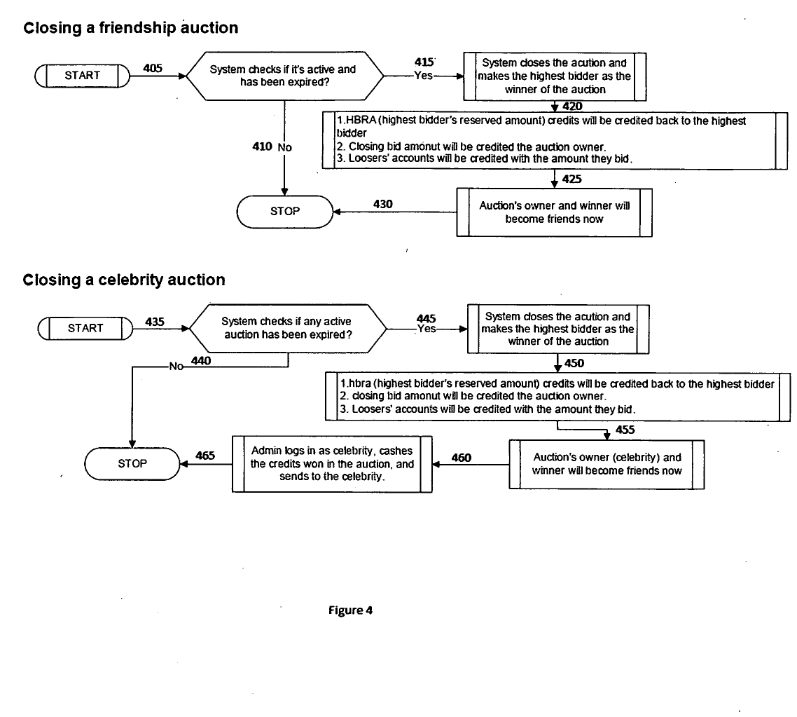

FIG. 3 illustrates a flowchart model showing the steps that are carried out by the agent for bidding in an auction with respect to one embodiment of the present invention. In step 305, the agent starts the bidding application for the auction and the administrator checks if it is a celebrity auction. In step 315, if is the auction is not a celebrity auction, the agent, hereinafter referred to as bidding agent, can bid for the auction to become friends with the auction owner, if he/she satisfies the conditions. The first conditions is if the sanitary agent can be friends with any other agent, secondly the sinful agent can be friends with either sanitary or another sinful agent, and lastly if the child agent can be friends with either sanitary agent or another child agent. If the conditions are not satisfied in step 315, the system application stops. Whereas if the conditions are satisfied, in step 320 the bidding agent bids for the auction entering the amount (x)>=minimum bid amount to become the highest bidder. In step 325, the system checks whether the agent has enough credits in his/her account. In step 330, if the agent does not have enough credit, then the system application stops.

In step 335, if the auction is a celebrity auction, the bidding agent bids for the auction entering the amount (x)>=minimum bid amount (mba) to become the highest bidder. In step 340, the system checks if the agent has enough celebrity credits. If the agent does not have enough credits, the system application stops in step 345.

In step 350, system checks if there is any highest bidder with auto-bidding process. If yes, then in step 355, the system checks for if the amount (x) is greater than the sum of minimum bid amount (mba) and the highest bidder's reserved amount (hbra). In step 360, if the amount (x) is not greater than the sum of minimum bid amount (mba) and the highest bidder's reserved amount (hbra) in step 350, the amount (x) credits will be debited from the new bidder's account to place a bid in step 365. Now, the minimum bid amount (mba) will be the sum of the amount (x) and the bid increment for the current amount range (BI). Further, the system debits the amount (t), which is the minimum of the bid increment for the current amount range (BI) and the highest bidder's reserved amount (hbra) from the highest bidder's account to place a bid (auto bid) on behalf of him/her. Now the new minimum bid amount (mba) is equal to the sum of the minimum bid amount, and the amount (t), and the bid increment for the current amount range (BI). Thus the highest bidder continues to be the highest bidder, and the bidder will be prompted that he/she is no longer a highest bidder and thus the system application ends in step 365.

Whereas if the amount (x) is greater than the sum of minimum bid amount (mba) and the highest bidder's reserved amount (hbra), in step 370, the system debits the amount highest bidder's reserved amount (hbra) from the highest bidder's account to place a bid (autobid) on behalf of him/her and emails the highest bidder that he could no longer be the highest bidder for the auction. Therefore, now the mba (minimum bid amount) is equal to the sum of minimum bid amount and the highest bidder's reserved amount (hbra). And the amount (x) credits will be debited from the new bidder's account and the system places a bid with the minimum bid amount (mba) credits and reserves the highest bidder's reserved amount (hbra) credits in auto-bidding process. Now the mba (minimum bid amount) is equal to the sum of the minimum bid amount and the bid increment for the current amount range (BI). Thus the bidder becomes the highest bidder and the system application ends in step 375.

In there is no highest bidder with auto-bidding process, in step 380, the system checks if the amount (x) is greater than the minimum bid amount. If the amount (x) is greater, the amount (x) credits will be debited from the bidder's account in step 385. Further the system places a bid with the minimum bid amount (mba) credits and reserves x-mba credits in auto-bidding process on behalf of this agent (auto bidder) for the next bids when some other bids for the auction. Now the minimum bid amount (mba) is equal to the minimum bid amount and the bid increment for the current amount range (BI), and thus the bidder become the highest bidder and the system application ends in step 375. If the amount (x) is not greater than the minimum bid amount, in the step 390, the amount (x) credits will be debited from the bidder's account to place a bid. Thus the new minimum bid amount (mba) is equal to the minimum bid amount and the bid increment for the current amount range (BI). Lastly in step 395, the bidder becomes the highest bidder and the system application ends in step 375.

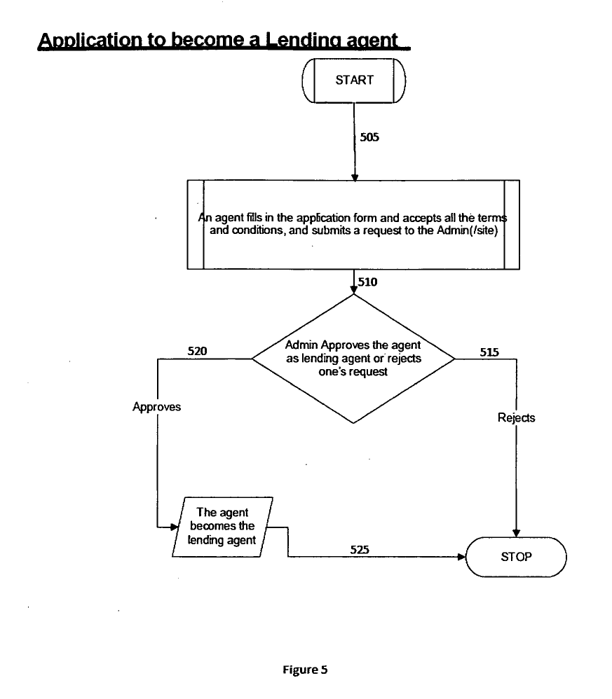

FIG. 4 illustrates a flowchart model showing the steps that are carried out by the agent to purchase credit with respect to one embodiment of the present invention.

In step 405, the agent starts the application for closing the friendship auction and the system checks if is active or have been expires. In step 410, the application is stopped if the auction is not expired.

If the auction is expired, in step 415, the system closes the auction and makes the highest bidder as the winner of the auction. In step 420, the HBRA (highest bidder's reserved amount) credits will be credited back to the highest bidder. Further, the closing bid amount will be credited back to the highest bidder and the loser's account will be credited with the amount they bid. In step 425, the auction owner and the winner will be friends now and the application will be stopped in step 430.

In step 435, the application for closing a celebrity auction will start and system checks if any active auction has been expired. If the active auction is not expired, the application will end in step 440. If the active auction is expired, in step 445 the system closes the auction and makes the highest bidder as the winner of the auction. In step 450, the HBRA (highest bidder's reserved amount) credits will be credited back to the highest bidder. Further, the closing bid amount will be credited back to the highest bidder and the loser's account will be credited with the amount they bid. In step 455, the auction owner and the winner will be friends now. Finally in step 460, the administrator logs in as a celebrity, cashes the credits won in the auction, and sends to the celebrity. The application is stopped in step 465.

FIG. 5 illustrates a flowchart model showing the steps that are carried out by the agent to become a lending agent with respect to one embodiment of the present invention.

In step 505, the agent starts the application to become a lending agent, and the agent fills in an application form and accepts all the terms and conditions, and submits a request to the administrator. In step 510, the administrator approves the agent as lending agent or reject's agent's request. If the administrator does not approve the agent's request, the agent does not become the lending agent in step 515 and the application ends. If the administrator approves the agent's request, in step 520, the agent becomes the lending agent and the application ends in step 525.

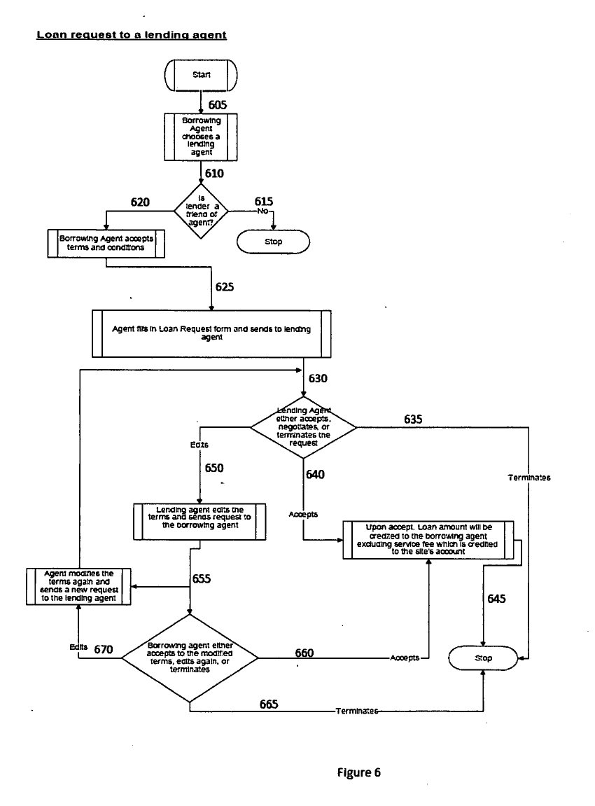

FIG. 6 illustrates a flowchart model showing the steps that are carried out for a loan request to a lending agent with respect to one embodiment of the present invention.

In step 605, the application for loan request to a lending agents starts and the borrowing agent chooses a lending agent. In step 610, the system checks if the lending agent is a friend of a borrowing agent. If the lending agent is not a friend of a borrowing agent, the application ends in step 615. If the lending agent is a friend of the borrowing agent, the borrowing agent accepts the terms and conditions in the step 620. In step 625, the agent fills in loan request form and sends to lending agent. In step 630, the lending agent either accepts, or negotiates, or terminates the request of the borrowing agent. If the lending agent terminates the request of borrowing agent, the application end sin step 635. If the lending agent accepts the request of borrowing agent, in step 640, the loan amount will be credited to the borrowing agent, excluding the service fee which is credited the site account and the application ends in step 645.

If the lending agent negotiates the request of borrowing agent, the lending agent edits the terms and sends request to borrowing agent in step 650. In step 655, the borrowing agent either accepts, or terminates, or negotiates the modified terms by the lending agent. If the borrowing agent terminates the modified terms of the lending agent, the application stops in step 665. If the borrowing agent accepts the terms of the lending agent in step 660, the loan amount will be credited to the borrowing agent, excluding the service fee which is credited the site account and the application ends. If the borrowing agent modifies and edits the modified term, and sends again a new request to the lending agent in step 670, the borrowing agent is diverted back to the step 630.

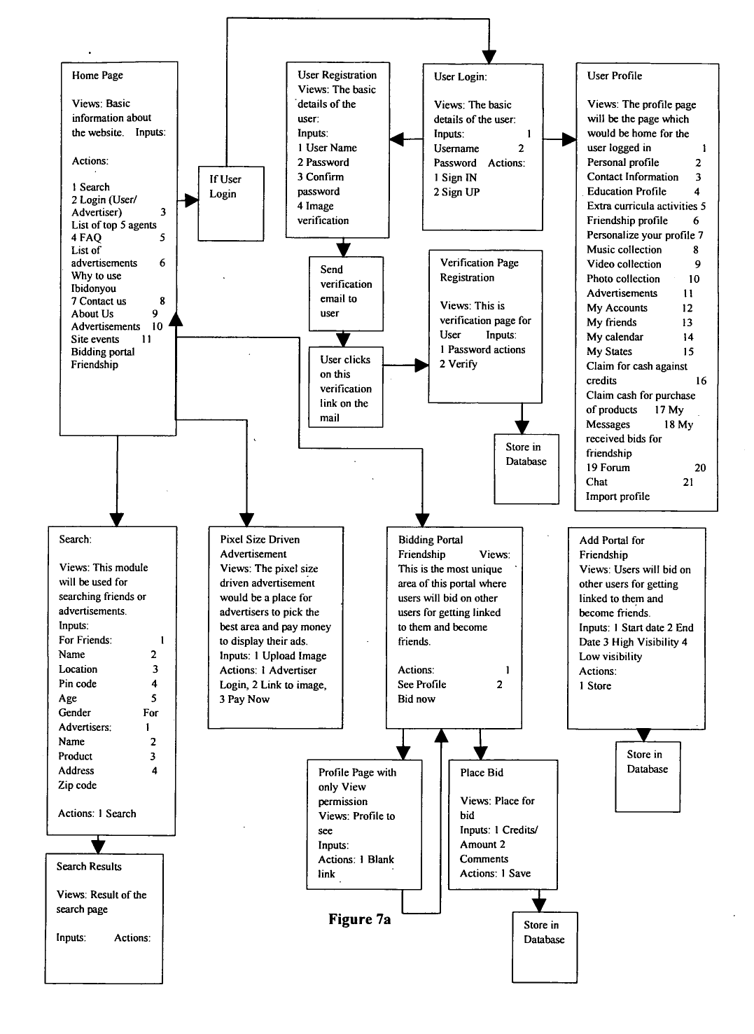

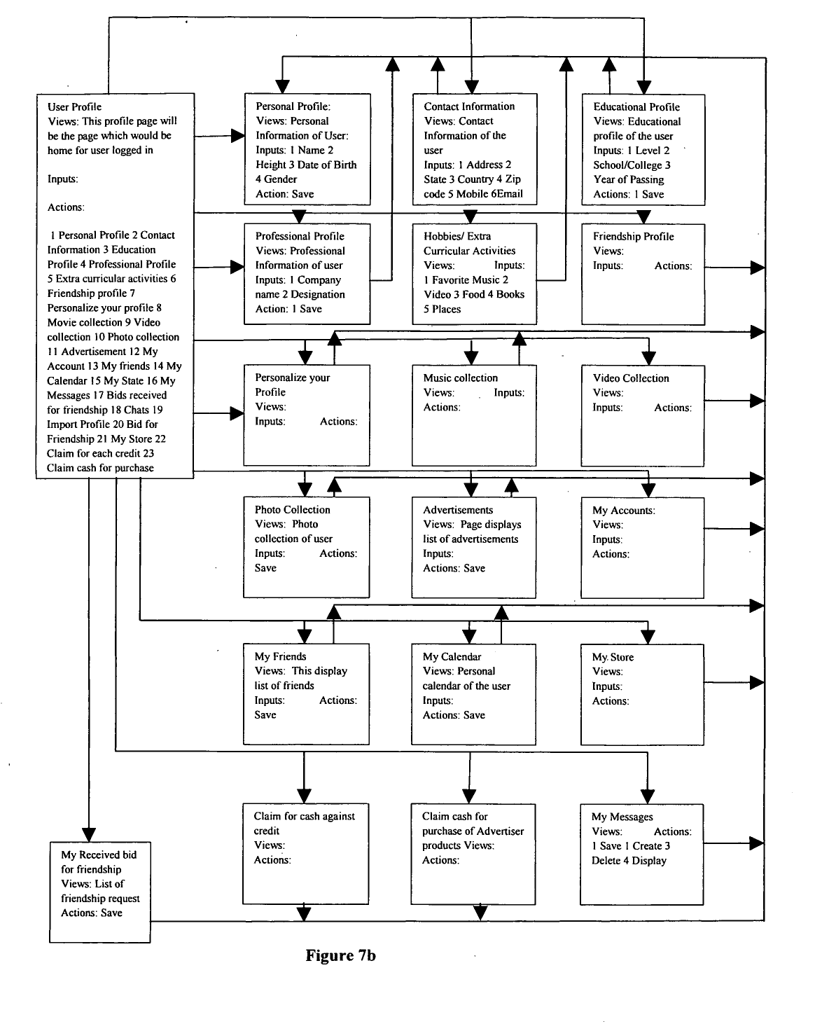

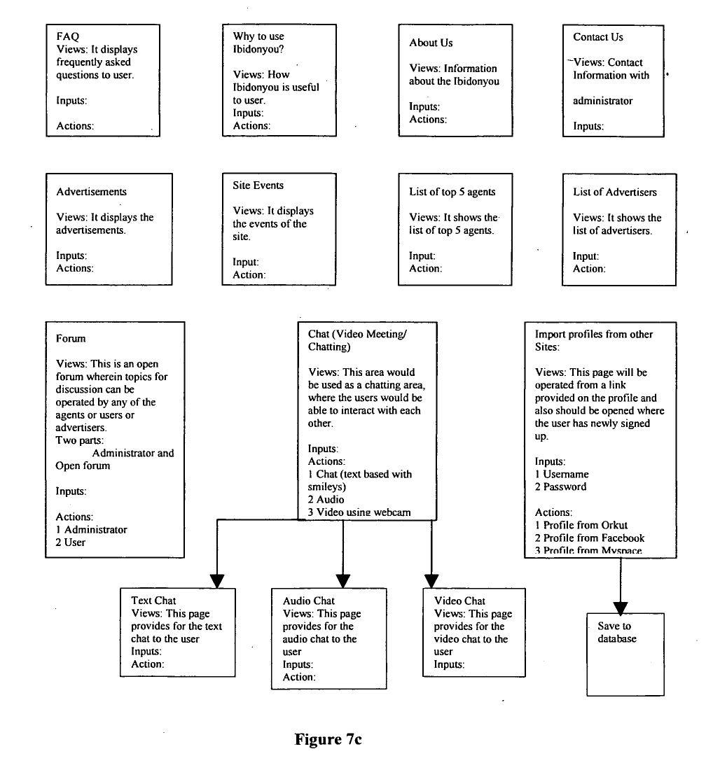

FIGS. 7a, 7b, 7c, and 7d illustrate a flowchart model for exemplary webpages with respect to one embodiment of the present invention. The figures illustrate the non limiting example of the website that may be used to establish the agent profile. As shown in the FIG. 7a, the home page of the website has a number of actions, but is not limited to such as search, login option for the agent and the administrator, list of top five agents, FAQ (frequently ask questions), the list of advertisers, why to use, bid on you, contact us, about us, advertisements, and bidding portal friendships. The agent needs to register by filling in the basic details such as a username and a password.

The agent's profile is divided into sub categories such as a personal profile having information such as the name, gender, date of birth, and the like. The contact information profile having information such as the contact address, electronic mails ids, contact number, and the like. The educational profile will include information such as the name of school, name of college, and the like. The professional profile will include information such as the name of the company, job description, and the like. A hobbies profile will include information such as favorite music, favorite videos, favorite sports, and the like. A friendship profile will include information such as the marital status and the like. An advertisement profile will list out the list of advertisement selected by the agent in his/her profile. The invention is not limited to the above mentioned sub categories of the agent profile, and will include other sub categories also such as My friend, My calendar, My store, My accounts, My messages, My photos, and the like.

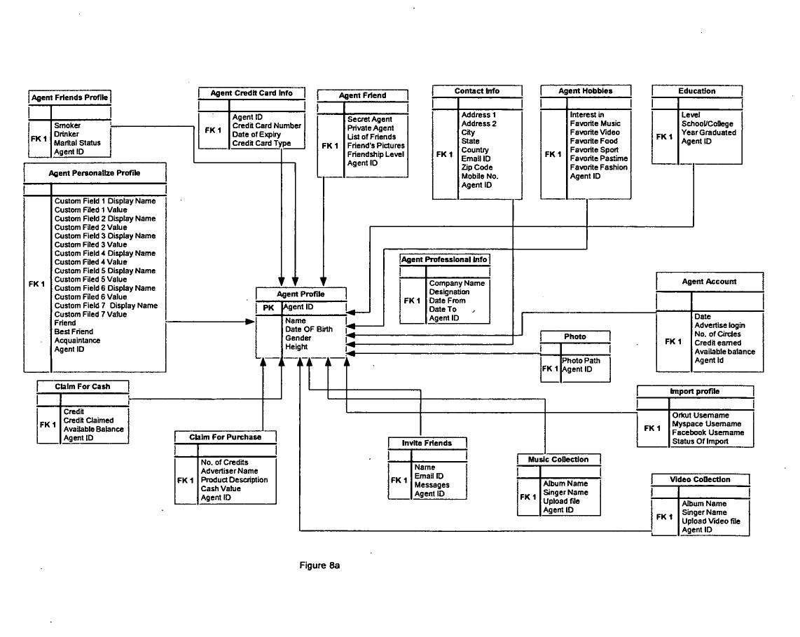

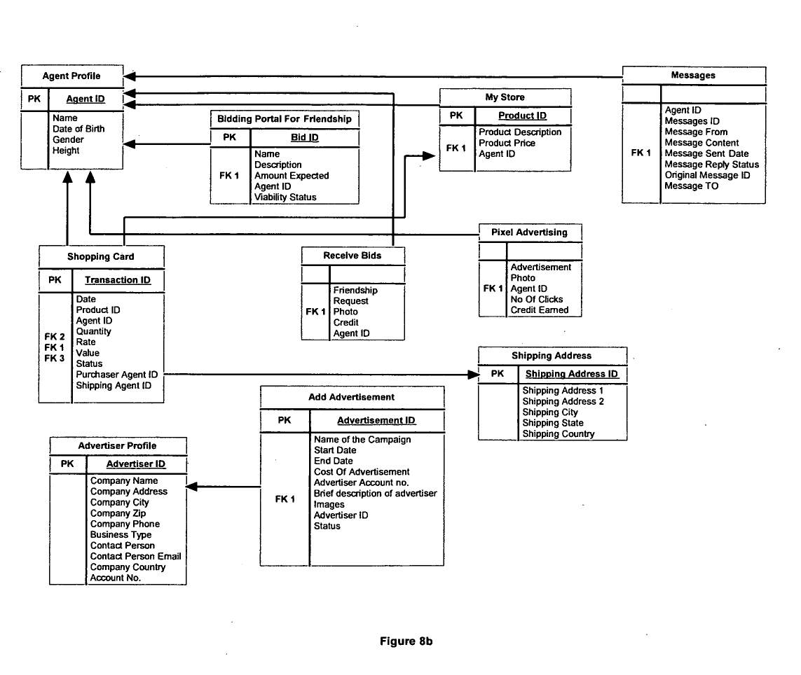

The agent is further provided with the chat option which will include a text chat, a video chat, and an audio chat. The advertiser login will include the basic details of the advertiser such as filling up the username and the password. The advertiser profile will have the action of the advertisement management where the advertiser has the options to add, delete, edit, and make the advertisement campaign online/offline. FIGS. 8a and 8b also further illustrate a flow chart for exemplary webpage's with respect to one embodiment of the present invention. The figures illustrate the non limiting example of the website that may be used to establish the agent profile.

FIG. 9 is a schematic illustration of a scrolling display of prize winners with respect to one embodiment to the present invention. As shown in the figure and embodied herein, each winner appears for the one week from when they open their treasure chest and discover their prize. Also, a photo click enabled link to the agent's profile is provided.

Although the subject matter is described in considerable detail with reference to certain embodiments thereof, other embodiments are possible. As such, the spirit and scope of the appended claims should not be limited to the description of the preferred embodiment contained therein.

I/We claim:

1. A method to monetize a social network system, which comprises:
Providing a server configured with a web based social network system, wherein said social network system has at least one agent, and wherein said social networking system provides each of said agent with individual profiles;
Providing at least one vendor to advertise at least one advertising object, wherein each of said agents is allowed to incorporate said advertising objects in their respective said individual profiles;
Providing an auction option to said agent to go bid on friendship with each of other said agents of said social network system; and
Providing said agents with a credit based on clicking on said advertising objects in their said profile of said social network system.

2. The method of claim 1, wherein said agent receives 50 “New Agent” credits when said agent registers in said social networking system.

3. The method of claim 1, wherein each of said agents is allowed to customize their said profiles respectively with said advertising objects of their choice.

4. The method of claim 1, wherein said advertising objects are sponsored by a plurality of vendors.

5. The method of claim 1, wherein the credits earned by each of said agents may preferably be of cash value, wherein said credits may preferably be used for purpose of bidding fellow agents, and at, vendor online stores, and at retail websites.

6. The method of claim 1, wherein each of said agent profile comprises at least one searchable field.

7. The method of claim 1, wherein a referral system is provided for credits for clicks on said advertising objects in the event a visitor starts at an original profile and then clicks to said agent friend of the original profile with subsequent advertising object placement click.

8. The method of claim 1, wherein said agent is provided with a social profile interlink wherein said agents can import their existing profiles from another website to said social networking system of the present invention.

9. The method of claim 1, wherein each of said agents of said social network system is provided with a friend hierarchy for placing friends on particular levels associated with availability to particular profile pages inter-linking to other friends.

10. The method of claim 1, wherein said social network system provides a “Treasure Chest” feature in which said vendors and website providers offer prizes to users for promotional purposes.

11. The method of claim 1, wherein said social network system provides a “Look-Alike” feature allowing each of said agents to search and bid on friends based on particular physical features.

12. The method of claim 1, wherein said social networking system provides a feature in which a class of said agent will be established based on the number of credits said Agent maintains in his account.

13. The method of claim 1, wherein each of said agent profile will have a public section, wherein said public section will include a user name, a main picture, a synopsis provided by said agent, and said advertising objects chosen by said agent respectively.

14. The method of claim 13, wherein said agent can privatize their respective said profiles except for their said user name and said main picture by paying the credit, and thereby receive a private agent status.

15. The method of claim 14, wherein said private agent is allowed to use their respective credits for merchandising.

16. The method of claim 1, wherein when said agent secures a friendship with another said agent by winning a bid on friendship, either of the two said agents are given a Referral Agent status.

17. The method of claim 1, wherein a fully customizable multi-agent profile system is provided.

18. The method of claim 1, wherein said agents can participate in the auction of a celebrity agent and add said celebrity agents in their friend list.
